(19) United States
(12) Patent Application Publication
(10) Pub. No.: US 2007/0075564 A1
(43) Pub. Date: Apr. 5, 2007

(54) Tailgate of a motor vehicle

(75) Inventors: Heinz Soja, Weil Der Stadt (DE); Okan Gonuldinc, Ostfildern (DE); Georg Erdelitsch, Wiernsheim (DE); Ray Mehdiyoun, Vaihingen (DE); Jorg Ocker, Lorch (DE)

Correspondence Address: LERNER GREENBERG STEMER LLP, P O BOX 2480, HOLLYWOOD, FL, 33022-2480, US

(73) Assignee: Dr. Ing. h.c.F. Porsche AG

(21) Appl. No.: 11/541,814

(22) Filed: Oct. 2, 2006

(30) Foreign Application Priority Data
Sep. 30, 2005 (DE) 10 2005 046 891.8

(51) Int. Cl. B60J 5/10

(52) U.S. Cl. 296/146.8

(57) ABSTRACT

A tailgate of a motor vehicle has a vibration absorber configured as a spring-mass system. In order to reduce a vibrating of the tailgate in the driving mode, it is provided that the vibration absorber is fastened as a separate component to the tailgate. The advantages mainly obtained are that of enabling the separate absorber mass to be coordinated with the tailgate in a simple manner.

### CROSS-REFERENCE TO RELATED APPLICATION

This application claims the priority, under 35 U.S.C. §119, of German application DE 10 2005 046 891.8, filed Sep. 30, 2005; the prior application is herewith incorporated by reference in its entirety.

### BACKGROUND OF THE INVENTION

### FIELD OF THE INVENTION

The invention is based on a tailgate of a motor vehicle, which has a vibration absorber configured as a spring-mass system.

A tailgate forming the generic type is known from German patent DE 195 24 160 C1. The tailgate there itself forms the absorber mass which is supported in relation to the body shell of the motor vehicle via a spring/damper system. The spring/damper system together with the absorber mass therefore constitutes the spring-mass system. The spring/damper system in the known tailgate is configured as a rubber element on which the lock bow of the tailgate lock is supported. Alternatively, the seal which surrounds the bodywork opening and on which the tailgate rests can serve as the spring/damper system.

Published, non-prosecuted German patent DE 40 30 990 A1 reveals, as a vibration absorber, a spring-mass system which is disposed in a windshield frame of a convertible.

### SUMMARY OF THE INVENTION

It is accordingly an object of the invention to provide a tailgate of a motor vehicle which overcomes the above-mentioned disadvantages of the prior art devices of this general type, which, while having a simple construction, is adequately damped in its vibration behavior.

With the foregoing and other objects in view there is provided, in accordance with the invention, a tailgate of a motor vehicle. The tailgate contains a vibration absorber configured as a spring-mass system, the vibration absorber being fastened as a separate component to the tailgate.

The advantages mainly obtained with the invention are considered that of enabling the separate absorber mass to be coordinated with the tailgate in a simple manner. Thus, the vibration absorber according to the invention, which is fastened as a separate component to the tailgate, for example is matched to tailgates in different ways, since the latter may differ in weight. In particular, optional equipment items of the motor vehicle may influence the weight of the tailgate. Optional equipment items of this type may be, for example, optionally provided wipers, opening aids for the tailgate, different rear windows for the tailgate, or the like. In the case of the tailgate known from the prior art, these optional equipment items may lead to a miscoordination of the spring-mass system, as a result of which the absorber effect may possibly no longer be satisfactory. Furthermore, it has been shown that the vibration absorber according to the invention can also be used for tailgates which are used in vehicles with a body in the manner of a coupe. In the case of vehicles of this type, the tailgate lies in a plane which is inclined only by a small angle in relation to an imaginary horizontal plane. In the case of configurations of this type, the tailgate may have an increased tendency to vibrate. However, it has been shown that, with the vibration absorber according to the invention, even tailgates of this type can be damped such that the knocking noises, which are described in the prior art, within the motor vehicle can be completely prevented or at least very largely avoided.

According to a development of the invention, it is advantageous for the damping of the tailgate to be able to take place with a relatively small absorber mass.

In the case of an exemplary embodiment, the space which already exists in many cases between an outside panel and an inside panel of the tailgate is used for the arrangement of the vibration absorber. Additional installation space for the vibration absorber therefore does not need to be provided.

An exemplary embodiment is particularly preferred, according to which the vibration absorber is inserted into a recess on the inside panel. The vibration absorber can accordingly be suspended on the edge surrounding the recess.

In an exemplary embodiment, the vibration absorber is covered by an interior trim panel.

In order to be able to suspend the vibration absorber permanently and securely, the edge which surrounds the recess is of reinforced construction, preferably peripherally. The reinforcement of the edge can be formed, for example, by an inside panel which is configured with a greater material thickness in the region of the edge than in other regions. Panels of this type are also referred to as tailored blanks. However, an exemplary embodiment is particularly preferred, in which the reinforcement of the edge is formed by a separate reinforcing part which is placed onto the inside panel. The reinforcing part is preferably configured as a peripheral frame and is connected to the inside panel of the tailgate. In this case, the reinforcing part can be a sheet-metal part.

In order to provide an enlarged installation space for the vibration absorber, the edge of the recess can be configured as a protuberance or can have a protuberance. There is therefore increased space between inside panel and outside panel.

Other features which are considered as characteristic for the invention are set forth in the appended claims.

Although the invention is illustrated and described herein as embodied in a tailgate of a motor vehicle, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic, perspective view of a motor vehicle with a tailgate according to the invention; and

FIG. 2 is diagrammatic, perspective view of the tailgate from the inside.

### DESCRIPTION OF THE PREFERRED EMBODIMENTS

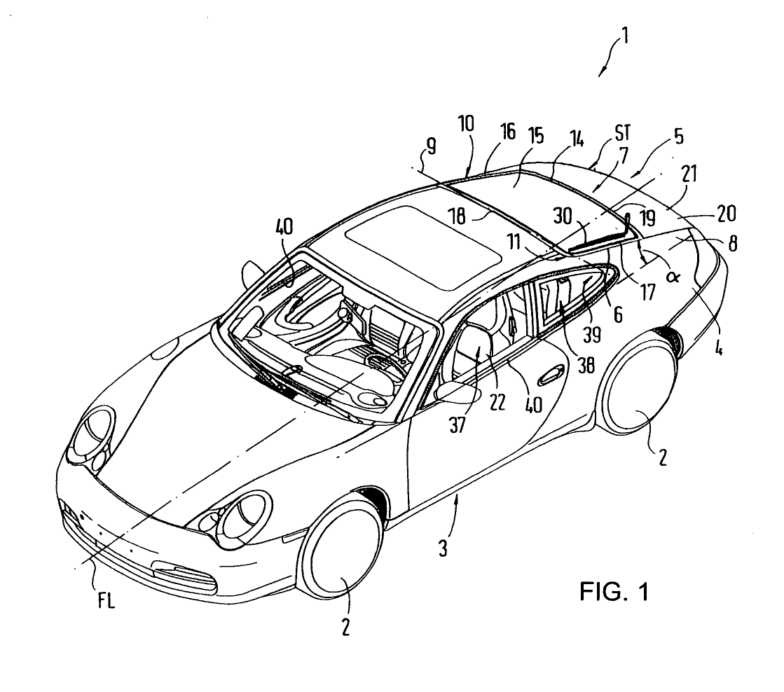

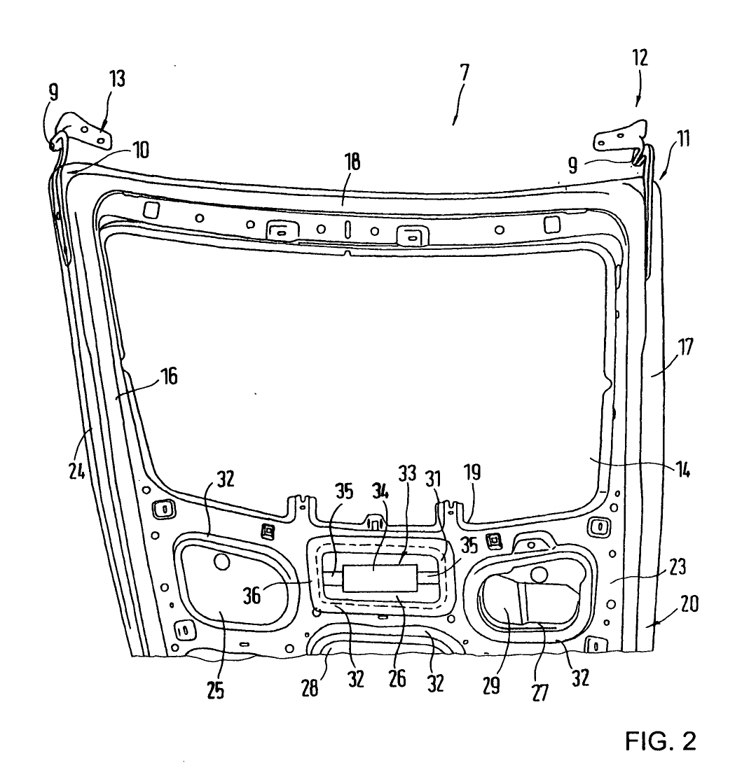

Referring now to the figures of the drawing in detail and first, particularly, to FIG. 1 thereof, there is shown a motor vehicle 1 that contains a body 3, which is supported by wheels 2, with a bodywork 4 which, in a rear region 5, has a bodywork opening 6 into which a tailgate 7 is inserted. The tailgate 7 is shown in FIG. 1 in a closed position ST in which it is substantially flush with the outer skin 8 of the bodywork 4. The tailgate 7 can be folded about a pivot axis 9, which runs transversely to a vehicle longitudinal axis FL, into an open position. For this purpose, hinges 12 and 13 (see FIG. 2) are fitted in the upper corner regions 10 and 11 of the tailgate 7 and are also connected to the body 3. The tailgate 7, which has a large surface area, has a window cutout 14 into which a rear window 15 is fixedly inserted. The window cutout 14 is bounded by lateral frame parts 16 and 17 which are connected to each other in the corner regions 10 and 11 via a transverse frame part 18. A lower boundary edge 19 of the window cutout 14 is adjoined by an opaque section 20 of the tailgate 7. The section 20 is formed by an outside panel which also has the frame parts 16 and 17 and the frame transverse part 18. An outside panel 21 consequently has the window cutout 14. To support the outside panel 21, an inside panel 23, which likewise has the window cutout 14, is fastened to the side of the outside panel which faces a vehicle interior 22. The inside panel 23 and the outside panel 21 are preferably connected fixedly to each other at least on an outer tailgate edge 24. A partial region of the inside panel 23 situated below the section 20 has one or more recesses 25, 26, 27, 28 of which a recess 26 lies adjacent to the lower boundary edge 19 and approximately on the vehicle longitudinal axis FL, i.e. is formed approximately centrally in the inside panel 23. With regard to the measured length of the tailgate 7 in the direction of the vehicle longitudinal axis FL, the recess 26 is likewise formed on the tailgate 7 approximately centrally. A driving motor 29 for a rear window wiper 30 (FIG. 1) can be inserted into another, in particular lateral recess 25 or 27.

The central recess 26 is bounded by an edge 31 which has a protuberance 32 which is directed in the direction of the vehicle interior 22 and furthermore can also be provided for the other recesses 25, 27, 28. The protuberance 32 consequently forms an elevation on the inside of the inside panel 23, which side faces the vehicle interior 22, and enlarges the intermediate space present between inside panel 23 and outside panel 21.

A vibration absorber 33, which is configured as a spring-mass system and therefore has an absorber mass 34 and at least one spring element 35 as a suspension device, is inserted as a separate component into the central recess 26. In the exemplary embodiment shown, the absorber mass 34 is suspended by two spring elements 35. For this purpose, the spring elements 35, which can have a damping effect, are connected to the edge 31 of the inside panel 23, so that the vibration absorber 33 comes to lie within the central recess 26. In this case, the vibration absorber 33 is fastened to the inside panel 23 in such a manner that it comes to lie at least in some sections within the tailgate 7 in the intermediate space bounded by the outside panel 21 and inside panel 23. For secure suspension of the vibration absorber 33, the edge 31 of the recess 26 is of reinforced construction. A reinforcement can surround the recess 26 in a strip-shaped manner or in the manner of a frame. The reinforcement is configured on the inside of the inside panel 23, which side faces the vehicle interior 22, as a separate reinforcing part 36 in the form of a peripheral frame which is connected fixedly to the inside panel 23. The peripheral frame of the reinforcing part 36 is preferably configured as a sheet-metal part. Alternatively, it would be conceivable to fasten the reinforcing part 36 to that side of the inside panel 23 which faces the outside panel 21. In a further embodiment, the inside panel 23 could also be configured as a tailored blank which has a material section with greater material thickness as reinforcing part 36 in the region of the edge 31. The strip-shaped reinforcing part 36 preferably extends over the entire protuberance 32 of the recess 26.

A non-illustrated interior trim panel for the tailgate can also be fitted on the inside of the inside panel 23, which side faces the vehicle interior 22, as a result of which the parts fitted to the tailgate 7, such as, for example, the driving motor 29 and the vibration absorber 33, are covered by the interior trim panel.

As FIG. 1 also shows, the motor vehicle 1 is configured as a passenger vehicle, and, in the vehicle interior 22 behind a front seat row 37 or rear seat row 38, it has a loading compartment 39 or luggage compartment which is upwardly closed or opened up by the tailgate 7. The body 3 of the motor vehicle 1 is realized, in particular, as a coupe with a rear region 5 dropping to the rear in a relatively shallow manner. The tailgate 7 is therefore situated in a plane which, with respect to an imaginary horizontal plane in which, for example, a belt line 40 of the body 3 is situated, takes up an angle a which is smaller than 90°, in particular smaller than 45°, and, for example, lies between 10° and 35°.

We claim:

1. A tailgate of a motor vehicle, comprising:
a vibration absorber configured as a spring-mass system, said vibration absorber being fastened as a separate component to the tailgate.

2. The tailgate according to claim 1, wherein said vibration absorber is fastened approximately centrally in the tailgate.

3. The tailgate according to claim 1, further comprising:
at least one outside panel; and
at least one inside panel, said vibration absorber is disposed between said outside panel and said inside panel.

4. The tailgate according to claim 3, wherein said inside panel has a recess formed therein, and said vibration absorber is inserted into said recess.

5. The tailgate according to claim 3, further comprising an interior trim panel covering said inside panel.

6. The tailgate according to claim 4, wherein said inside panel has an edge surrounding said recess and is of reinforced construction, said vibration absorber is suspended on said edge.

7. The tailgate according to claim 6, wherein said edge of said recess is reinforced peripherally.

8. The tailgate according to claim 6, further comprising a reinforcing part which reinforces said edge of said recess and is disposed on said inside panel.

9. The tailgate according to claim 8, wherein said reinforcing part is a peripheral frame.

10. The tailgate according to claim 8, wherein said reinforcing part is a sheet-metal part.

11. The tailgate according to claim 6, wherein said edge of said recess has a protuberance.
